(19) United States
(12) Patent Application Publication
(10) Pub. No.: US 2006/0145053 A1
(43) Pub. Date: Jul. 6, 2006

(54) Electronic devices including dual-function electronic components, radiation-emitting components, radiation-sensing components, or any combination thereof

(76) Inventors: Matthew Stevenson, Santa Maria, CA (US); Gang Yu, Santa Barbara, CA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/027,658

(22) Filed: Dec. 30, 2004

(51) Int. Cl. G01J 1/32

(52) U.S. Cl. 250/205

(57) ABSTRACT

An electronic device can include circuitry that compensates for the emission intensity of a display, including a radiation-emitting component, in response to ambient radiation. In one embodiment, the circuitry includes a low-pass filter that can help to reduce the effect of quick changes in intensity of ambient radiation. In another embodiment, an electronic device includes a dual-function electronic component and a switch. The switch is configured to be closed at least during a portion of time while the dual-function electronic component is between an emission mode and a sensing mode. In still another embodiment, the circuitry includes a current amplifier that is configured to amplify a current from a radiation-sensing component to produce an amplified current. In yet another embodiment, the circuitry includes an I-V converter and a voltage amplifier. The I-V converter converts a current from a sensor to a voltage, and the voltage amplifier amplifies that voltage.

### BACKGROUND OF THE INVENTION

1. Field of the Invention

The invention relates generally to electronic devices, and more specifically to electronic devices including dual-function electronic components, radiation-emitting components, radiation-sensing components, or any combination thereof.

2. Description of the Related Art

Many electronic devices, including cellular phones, personal digital assistants (PDAs), related portable electronics, etc. include displays. The displays are hindered by their reliance upon an appropriate level of ambient light to make the display readable. For an emissive display, an overly bright environment can cause the display to lose contrast and become unreadable. For a non-emissive display, such as a liquid crystal display (LCD), an overly dark environment can render the display unreadable because there is insufficient incident light. To overcome this lack of ambient light, a backlight for a non-emissive display can be set at an emission intensity level high enough to be readable in the brightest light, or provided with a manual brightness control. Therefore, a backlight is provided that can be operated by the user when desired. Other types of displays, such as an organic light-emitting diode (“OLED”) display, can have similar issues with brightness levels. While these approaches can render the display readable, they may consume more power than is necessary, require the user of the device to manually operate a control, or a combination thereof. Unnecessary power consumption is undesired. The operation of a manual control is also problematic because the electronic devices are often used in situations in which it is impractical to operate a manual control, for example, using a cellular phone while driving a car, flying a fighter jet in a combat situation, etc.

### SUMMARY OF THE INVENTION

An electronic device includes a low-pass filter configured to receive an output signal from a radiation-sensing component or a first derived signal derived from the output signal to produce a filtered signal. The output signal corresponds to an intensity of ambient radiation sensed by the radiation-sensing component. The electronic device also includes a first radiation-emitting component designed to emit a first radiation based at least in part on the filtered signal or a second derived signal derived from the filtered signal.

In another embodiment, an electronic device includes a first dual-function electronic component and a first switch. The first dual-function electronic component has a first terminal and a second terminal, wherein the first dual-function electronic component is designed to emit a first radiation while in a first mode and to sense ambient radiation while in a second mode. The first switch has a first terminal and a second terminal. The first terminal of the first switch is connected to the first terminal of the first dual-function electronic component, and the second terminal of the first switch is connected to the second terminal of the first dual-function electronic component. The first switch is configured to be: closed at least during a portion of time while the first dual-function electronic component is between the first and second modes; open at least during a portion of time while the first dual-function electronic component is in the first mode; and open at least during a portion of time while the first dual-function electronic component is in the second mode.

In still another embodiment, an electronic device includes a current amplifier that is configured to amplify an output current from a radiation-sensing component to produce an amplified current, wherein the output current corresponds to an intensity of ambient radiation sensed by the radiation-sensing component. The electronic device also includes a first radiation-emitting component configured to emit a first radiation based at least in part on the amplified current.

In yet another embodiment, an electronic device includes an I-V converter configured to convert an output current from a radiation-sensing component to a converted voltage, wherein the output current corresponds to an intensity of ambient radiation sensed by the radiation-sensing component. The electronic device also includes a voltage amplifier that is connected in series with the I-V converter, wherein the voltage amplifier is configured to amplify the converted voltage from the I-V converter to produce an amplified voltage. The electronic device further includes a first radiation-emitting component configured to emit a first radiation based at least in part on the amplified voltage or a first derived signal derived from the amplified voltage.

The foregoing general description and the following detailed description are exemplary and explanatory only and are not restrictive of the invention, as defined in the appended claims.

### BRIEF DESCRIPTION OF THE DRAWINGS

The invention is illustrated by way of example and not limitation in the accompanying figures.

FIG. 1 includes a block diagram illustrating an electronic device that includes a display with automatic intensity control.

FIG. 2 includes a graph illustrating sensed current as a function of ambient radiation intensity.

FIG. 3 includes a graph illustrating the emission intensity as a function of supplied current to a radiation-emitting component.

FIG. 4 includes a graph illustrating a relationship between emission intensity and ambient radiation intensity.

FIG. 5 includes a block diagram illustrating an electronic device that has a different control portion as compared to the control portion in FIG. 1.

FIG. 6 includes a schematic diagram of an electronic device including a dual-function electronic component.

FIG. 7 includes a graph illustrating the timing of the switching signals for the electronic device of FIG. 6.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION

An electronic device includes a low-pass filter configured to receive an output signal from a radiation-sensing component or a first derived signal derived from the output signal to produce a filtered signal. The output signal corresponds to an intensity of ambient radiation sensed by the radiation-sensing component. The electronic device also includes a first radiation-emitting component designed to emit a first radiation based at least in part on the filtered signal or a second derived signal derived from the filtered signal.

In another embodiment, the electronic device further includes a first controller, wherein the electronic device is configured such that the output signal from the radiation-sensing component or the first derived signal passes through the low-pass filter before reaching the first controller, and the first controller is configured to control an intensity of the first radiation emitted from the first radiation-emitting component at least partially in response to the filtered signal or the second derived signal. In a specific embodiment, the electronic device further includes an amplifier configured to amplify the output signal from the radiation-sensing component or a third derived signal derived from the output signal to produce the first derived signal. In a more specific embodiment, the electronic device further includes an I-V converter configured to convert the output signal, which is a current, to the third derived signal, which is a voltage, wherein the amplifier is configured to receive the third derived signal.

In still another specific embodiment, the first radiation-emitting component includes a first organic active layer. In a more specific embodiment, the electronic device further includes other radiation-emitting components substantially identical to the first radiation-emitting component. The first controller is configured to control intensities of the first radiation emitted from the other radiation-emitting components at least partially in response to the filtered signal. In another more specific embodiment, the electronic device further includes a second radiation-emitting component and a third radiation-emitting component. The first radiation has a first emission maximum at a first wavelength, the second radiation-emitting component is designed to emit a second radiation having a second emission maximum at a second wavelength, the third radiation-emitting component is designed to emit a third radiation having a third emission maximum at a third wavelength, and the first, second, and third wavelengths are different compared to one another.

In still a further specific embodiment, the electronic device further includes a second controller and a third controller. The second controller is configured to control an intensity of the second radiation emitted from the second radiation-emitting component at least partially in response to the filtered signal. The third controller is configured to control an intensity of the third radiation emitted from the third radiation-emitting component at least partially in response to the filtered signal. In another specific embodiment, the second radiation-emitting component includes a second organic active layer, the third radiation-emitting component includes a third organic active layer, and the first, second, and third organic active layers are different compared to one another. In yet another specific embodiment, the radiation-sensing component includes a second organic active layer.

In still another embodiment, the low-pass filter has an input terminal and an output terminal. The low-pass filter includes a resistive electronic component having a first terminal and a second terminal, wherein the first terminal is connected to the input terminal, and the second terminal is connected to the output terminal. The low-pass filter also includes a capacitive electronic component having a first electrode and a second electrode, wherein the first electrode is connected to the input terminal, and the second electrode is designed to be at a substantially constant voltage during at least a portion of time when the electronic device operates.

In one embodiment, an electronic device includes a first dual-function electronic component and a first switch. The first dual-function electronic component has a first terminal and a second terminal, wherein the first dual-function electronic component is designed to emit a first radiation while in a first mode and to sense ambient radiation while in a second mode. The first switch has a first terminal and a second terminal. The first terminal of the first switch is connected to the first terminal of the first dual-function electronic component, and the second terminal of the first switch is connected to the second terminal of the first dual-function electronic component. The first switch is configured to be: closed at least during a portion of time while the first dual-function electronic component is between the first and second modes; open at least during a portion of time while the first dual-function electronic component is in the first mode; and open at least during a portion of time while the first dual-function electronic component is in the second mode.

In another embodiment, the electronic device further includes a first controller and a second switch. The second switch has a first terminal connected to the first terminal of the first dual-function electronic component and a second terminal connected to an output of the first controller. The first controller is configured, when the second switch is closed, to control an intensity of the first radiation emitted from the first dual-function component. In a specific embodiment, the electronic device further includes an amplifier and a third switch. The third switch has a first terminal connected to the first terminal of the first dual-function electronic component and a second terminal coupled to an input of the amplifier. The amplifier is configured, when the third switch is closed, to amplify an output signal from the dual-function electronic component or a first derived signal derived from the output signal to produce an amplified signal. In a more specific embodiment, the electronic device further includes an I-V converter configured to convert the output signal, which is a current, to the first derived signal, which is a voltage. In a further specific embodiment, the first controller is configured to receive the amplified signal or a second derived signal from the amplified signal. In still a further specific embodiment, the electronic device further includes other dual-function electronic components substantially identical to the first dual-function electronic component, wherein the first controller is configured to control intensities of the first radiation emitted from the other dual-function electronic components.

In still another embodiment, the first dual-function electronic component includes a first organic active layer. In a specific embodiment, the electronic device further includes a second dual-function electronic component and a third dual-function electronic component. The first radiation has a first emission maximum at a first wavelength, the second dual-function electronic component is designed to emit a second radiation having a second emission maximum at a second wavelength, the third dual-function electronic component is designed to emit a third radiation having a third emission maximum at a third wavelength, and the first, second, and third wavelengths are different compared to one another. In a more specific embodiment, the second dual-function electronic component includes a second organic active layer, and the third dual-function electronic component includes a third organic active layer. The first, second, and third organic active layers are different compared to one another.

In one embodiment, an electronic device includes a current amplifier that is configured to amplify an output current from a radiation-sensing component to produce an amplified current, wherein the output current corresponds to an intensity of ambient radiation sensed by the radiation-sensing component. The electronic device also includes a first radiation-emitting component configured to emit a first radiation based at least in part on the amplified current.

In another embodiment, the electronic device further includes a controller that is configured to control an intensity of the first radiation emitted from the first radiation-emitting component. In a specific embodiment, the electronic device further includes a low-pass filter configured to receive the amplified current to produce a filtered current to be received by the controller.

In another specific embodiment, the first radiation-emitting component includes a first organic active layer. In a more specific embodiment, the electronic device further includes other radiation-emitting components substantially identical to the first radiation-emitting component, wherein the controller is configured to control intensities of the first radiation emitted from the other radiation-emitting components. In another more specific embodiment, the electronic device further includes a second radiation-emitting component and a third radiation-emitting component. The first radiation has a first emission maximum at a first wavelength, the second radiation-emitting component is designed to emit a second radiation having a second emission maximum at a second wavelength, the third radiation-emitting component is designed to emit a third radiation having a third emission maximum at a third wavelength, and the first, second, and third wavelengths are different compared to one another. In a further specific embodiment, the second radiation-emitting component includes a second organic active layer, the third radiation-emitting component includes a third organic active layer, and the first, second, and third organic active layers are different compared to one another.

In one embodiment, an electronic device includes an I-V converter configured to convert an output current from a radiation-sensing component to a converted voltage, wherein the output current corresponds to an intensity of ambient radiation sensed by the radiation-sensing component. The electronic device also includes a voltage amplifier that is connected in series with the I-V converter, wherein the voltage amplifier is configured to amplify the converted voltage from the I-V converter to produce an amplified voltage. The electronic device further includes a first radiation-emitting component configured to emit a first radiation based at least in part on the amplified voltage or a first derived signal derived from the amplified voltage.

In another embodiment, the electronic device further includes a controller, wherein the controller is configured to control an intensity of the first radiation emitted from the first radiation-emitting component at least partially in response to the amplified voltage or the first derived signal. In a specific embodiment, the first radiation-emitting component includes a first organic active layer. In more specific embodiment, the electronic device further includes other radiation-emitting components substantially identical to the first radiation-emitting component, wherein the controller is configured to control intensities of the first radiation emitted from the other radiation-emitting components. In another more specific embodiment, the electronic device further includes a second radiation-emitting component and a third radiation-emitting component. The first radiation has a first emission maximum at a first wavelength, the second radiation-emitting component is designed to emit a second radiation having a second emission maximum at a second wavelength, the third radiation-emitting component is designed to emit a third radiation having a third emission maximum at a third wavelength, and the first, second, and third wavelengths are different compared to one another. In a further more specific embodiment, the second radiation-emitting component includes a second organic active layer, the third radiation-emitting component includes a third organic active layer, and the first, second, and third organic active layers are different compared to one another.

In still another embodiment, the radiation-sensing component includes a second organic active layer. In another embodiment, the electronic device further includes a low-pass filter configured to receive the amplified voltage to produce a filtered signal, wherein the filtered signal is the first derived signal.

Other features and advantages of the invention will be apparent from the following detailed description, and from the claims. The detailed description first addresses Definitions and Clarification of Terms followed by the Electronic Device Including a Current Amplifier, Electronic Device Including a Control Circuit, Electronic Device Including a Dual-Function Electronic Component, Alternative Embodiments, Advantages, and finally Examples.

1. Definitions and Clarification of Terms

Before addressing details of embodiments described below, some terms are defined or clarified. The term “ambient radiation” is intended to mean radiation outside of an electronic device that is not produced by emission from the electronic device. Mary Ann—George and I couldn't quite decide on the best definition here . . . any thoughts?

The term “amplifier” is intended to mean an electronic component, circuit, or system that increases or decreases the amplitude of an input signal without changing the input signal from a current to a voltage, or vice versa. Unless expressly stated otherwise, an electronic component, circuit, or system that amplifies or de-amplifies a signal is an example of an amplifier.

The terms “array,” “peripheral circuitry,” and “remote circuitry” are intended to mean different areas or components. For example, an array may include pixels, cells, or other electronic devices within an orderly arrangement (usually designated by columns and rows) within a component. These electronic devices may be controlled locally on the component by peripheral circuitry, which may lie within the same component as the array but outside the array itself. Remote circuitry typically lies away from the peripheral circuitry and can send signals to or receive signals from the array (typically via the peripheral circuitry). The remote circuitry may also perform functions unrelated to the array.

The term “averaged,” when referring to a value, is intended to mean an intermediate value between a high value and a low value. For example, an averaged value can be an average, a geometric mean, or a median.

The term “capacitive electronic component” is intended to mean an electronic component configured to act as a capacitor when illustrated in a circuit diagram. Examples of capacitive electronic components include capacitor and transistor structures.

The term “connected,” with respect to electronic components, circuits, or portions thereof, is intended to mean that two or more electronic components, circuits, or any combination of at least one electronic component and at least one circuit do not have any intervening electronic component lying between them. Parasitic resistance, parasitic capacitance, or both are not considered electronic components for the purposes of this definition. In one embodiment, electronic components are connected when they are electrically shorted to one another and lie at substantially the same voltage. Note that electronic components can be connected together using fiber optic lines to allow optical signals to be transmitted between such electronic components.

The term “controller” is intended to mean a first electronic component, circuit, or system that controls a second electronic component, circuit, or system based at least in part on an input received by such first electronic component, circuit, or system.

The term “coupled” is intended to mean a connection, linking, or association of two or more electronic components, circuits, systems, or any combination of: (1) at least one electronic component, (2) at least one circuit, or (3) at least one system in such a way that a signal (e.g., current, voltage, or optical signal) may be transferred from one to another. A non-limiting example of “coupled” can include a direct connection between electronic component(s), circuit(s) or electronic component(s) or circuit(s) with switch(es) (e.g., transistor(s)) connected between them.

The term “derived,” when referring to signals, is intended to mean a signal that is different but originates from and corresponds to another signal. For example, a voltage can be derived from a current, and vice versa. In another example, an amplified voltage and an amplified current can be derived from an original voltage and an original current, respectively.

The term “dual-function electronic component” is intended to mean an electronic component that, while in a first state, performs a first function, and while in a second state, performs a second function different from a first function. An organic light-emitting diode (“OLED”), when properly configured within one or more circuits, is an example of a dual-function electronic component. When the voltage of the OLED's anode is sufficiently higher than the voltages of the OLED's cathode, the OLED emits radiation. When the voltage of OLED's anode is sufficiently lower than the voltages of the OLED's cathode, the OLED senses radiation.

The term “electronic component” is intended to mean a lowest level unit of a circuit that performs an electrical or electro-radiative (e.g., electro-optic) function. An electronic component may include a transistor, a diode, a photodiode, a resistor, a capacitor, an inductor, a semiconductor laser, an optical switch, or the like. An electronic component does not include parasitic resistance (e.g., resistance of a wire) or parasitic capacitance (e.g., capacitive coupling between two conductors connected to different electronic components where a capacitor between the conductors is unintended or incidental).

The term “electronic device” is intended to mean a collection of one or more electronic components, one or more circuits, or combinations thereof that collectively, when properly connected and supplied with the appropriate signal(s), performs a function. In one embodiment, an electronic device may include or be part of a system. An example of an electronic device includes a display, a sensor array, a computer system, an avionics system, an automobile, a cellular phone, or other consumer or industrial electronic product.

The term “emission maximum” is intended to mean the highest intensity of radiation emitted. The emission maximum has a corresponding wavelength or spectrum of wavelengths (e.g., red light, green light, or blue light).

The term “filtered signal” is intended to mean a signal that is output from a filter, such as a low-pass filter or a high-pass filter.

The term “I-V converter” is intended to mean an electronic component, circuit, or system that receives a current as an input signal and produces a voltage as an output signal.

The term “low-pass filter” is intended to mean an electronic component or circuit that (1) allows lower frequency signals to pass and substantially prevents higher frequency signals from passing or (2) outputs an averaged signal based on a variable input signal.

The term “organic active layer” is intended to mean one or more organic layers, wherein at least one of the organic layers, by itself, or when in contact with a dissimilar material, is capable of forming a rectifying junction.

The term “radiation-emitting component” is intended to mean an electronic component, which when properly biased, emits radiation at a targeted wavelength or spectrum of wavelengths. The radiation may be within the visible-light spectrum or outside the visible-light spectrum (ultraviolet (“UV”) or infrared (“IR”)). A light-emitting diode is an example of a radiation-emitting component.

The term “radiation-sensing component” is intended to mean an electronic component which can sense radiation at a targeted wavelength or spectrum of wavelengths. The radiation may be within the visible-light spectrum or outside the visible-light spectrum (UV or IR). IR sensor is an example of a radiation-sensing component.

The term “rectifying junction” is intended to mean a junction within a semiconductor layer or a junction formed by an interface between a semiconductor layer and a dissimilar material, in which charge carriers of one type flow easier in one direction through the junction compared to the opposite direction. A pn junction is an example of a rectifying junction that can be used as a diode.

The term “resistive electronic component” is intended to mean an electronic component configured to act as a resistor when illustrated in a circuit diagram. An example of a resistive electronic component includes a resistor or transistor structure.

The term “signal” is intended to mean a current, a voltage, an optical signal, or any combination thereof. The signal can be a voltage or current from a power supply or can represent, by itself or in combination with other signal(s), data or other information. Optical signals can be based on pulses, intensity, or a combination thereof. Signals may be substantially constant (e.g., power supply voltages) or may vary over time (e.g., one voltage for “on” at one time and another voltage for “off” at another time).

The term “switch” is intended to mean one or more electronic components configured to act as a switch when illustrated in a circuit diagram. Examples of switches include diode and transistor structures, mechanical (e.g., manual) switches, electro-mechanical switches (e.g., relays), etc. In one embodiment, a switch includes terminals through which current can flow, and a control that can be used to allow or adjust current flowing through the switch, or to keep current from flowing through the switch.

The term “substantially identical” is intended to mean that two or more objects are identical to each other or almost identical such that any difference between them is considered to be insignificant to one of ordinary skill in the art.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Additionally, for clarity purposes and to give a general sense of the scope of the embodiments described herein, the use of the “a” or “an” are employed to describe one or more articles to which “a” or “an” refers. Therefore, the description should be read to include one or at least one whenever “a” or “an” is used, and the singular also includes the plural unless it is clear that the contrary is meant otherwise. Group numbers corresponding to columns within the periodic table of the elements use the “New Notation” convention as seen in the CRC Handbook of Chemistry and Physics, 81^{st} Edition (2000).

To the extent not described herein, many details regarding specific materials, processing acts, and circuits are conventional and may be found in textbooks and other sources within the organic light-emitting diode display, photodetector, and semiconductor arts.

Unless otherwise defined, all technical and scientific terms used herein have the same meaning as commonly understood by one of ordinary skill in the art to which this invention belongs. Although suitable methods and materials are described herein for embodiments of the invention, or methods for making or using the same, other methods and materials similar or equivalent to those described can be used without departing from the scope of the invention. All publication, patent applications, patents, and other reference materials mentioned herein are incorporated by reference in their entirety. In case of conflict, the present specification, including definitions, will control. In addition, the materials, methods, and examples are illustrative only and not intended to be limited.

Other features and advantages of the invention will be apparent from the following detailed description, and from the claims.

2. Electronic Device Including a Current Amplifier

An electronic device can include a current amplifier to automatically control the emission intensity of a radiation-emitting component based on ambient radiation sensed by a radiation-sensing component. Such a configuration can allow for a display to automatically adjust for changing ambient radiation conditions, such as going from indoors to outdoors, from a room with no light on to the same room with a light on, or the reverse of either.

FIG. 1 includes a block diagram illustrating an electronic device 100 with automatic emission intensity control. In one embodiment, the electronic device 100 includes a display portion 102, a sensing portion 106, and a control portion 104. The display portion 102 comprises one or more radiation-emitting components 112. In one embodiment, the radiation-emitting components 112 are conventional light-emitting diodes, such as OLEDs that are configured to be forward biased (anodes at a higher voltage compared to the cathodes). In one embodiment, the radiation-emitting components 112 may be arranged as a matrix for a monochromatic or full-color display. For simplicity, only one radiation-emitting component 112 is illustrated in FIG. 1.

The sensing portion 106 includes one or more radiation-sensing components 116 that generate a signal indicative of the intensity of radiation sensed by the radiation-sensing components 116. In one embodiment, the radiation-sensing components 116 are conventional radiation sensors, and in one specific embodiment, the radiation-sensing components 116 are reverse biased OLEDs (the cathodes are at a higher voltage compared to the anodes) as described in more detail in U.S. Pat. No. 5,504,323. By using OLEDs for both the radiation-emitting and radiation-sensing components 112 and 116, fabrication processes can be simplified, as many of the materials and layers are the same for both. The radiation-emitting and radiation-sensing components 112 and 116 may include the same or different organic active layers. In one specific embodiment, the organic active layer within each of the radiation-emitting and radiation-sensing components 112 and 116 includes poly(2-methoxy-5-(2′-ethylhexyloxy)-1,4-phenylene vinylene (“MEH-PPV”), HB696 (a green light-emitting PPV derivative), HB699 (a green light-emitting PPV derivative), NRS02 (a yellow light-emitting MEH-PPV), other similar organic electroluminescent material, or any combination thereof.

Table 1 includes a list of photosensitivity and quantum efficiency for devices with different organic active layers at different thicknesses.

TABLE 1

| | | | Photosen- | External |
|---|---|---|---|---|
| | | | sitivity | quantum |
| | Organic Active Layer | | at 475 nm* | efficiency** |
| Device | Batch | Thickness(A) | mA/W | % ph/el |
| 1 | HB696 | 600 | 0.50 | 1.24 |
| 2 | HB696 | 700 | 0.43 | 1.07 |
| 3 | HB696 | 700 | 0.44 | 1.09 |
| 4 | HB696 | 1000 | 0.32 | 0.79 |
| 5 | HB696 | 1000 | 0.34 | 0.84 |
| 6 | HB696 | 700 | 0.44 | 1.09 |
| 7 | HB696 | 700 | 0.50 | 1.24 |
| 8 | HB696 | 700 | 0.43 | 1.07 |
| 9 | HB696 | 700 | 0.43 | 1.07 |
| 10 | HB696 | 700 | 0.43 | 1.07 |
| 11 | HB696 | 700 | 0.46 | 1.14 |
| 12 | HB696 | 700 | 0.43 | 1.07 |
| 13 | HB696 | 700 | 0.50 | 1.24 |
| 14 | HB696 | 700 | 0.61 | 1.51 |
| 15 | HB696 | 700 | 0.60 | 1.49 |
| 16 | HB696 | 700 | 0.58 | 1.44 |
| 17 | HB696 | 700 | 0.58 | 1.44 |
| 18 | HB696 | 700 | 0.59 | 1.46 |
| 19 | HB696 | 700 | 0.51 | 1.26 |
| 20 | HB699 | 700 | 0.27 | 0.67 |
| 21 | HB699 | 700 | 0.26 | 0.64 |
| 22 | HB699 | 700 | 0.27 | 0.27 |
| 23 | HB699 | 700 | 0.26 | 0.64 |
| 24 | NRS02 | 700 | 0.08 | 0.20 |
| 25 | NRS02 | 700 | 0.08 | 0.20 |
| 26 | NRS02 | 700 | 0.09 | 0.22 |
| 27 | NRS02 | 700 | 0.10 | 0.25 |
| 28 | NRS02 | 700 | 0.08 | 0.20 |
| 29 | NRS02 | 700 | 0.08 | 0.20 |
| 30 | NRS02 | 700 | 0.06 | 0.15 |
| 31 | NRS02 | 700 | 0.08 | 0.20 |
| 32 | NRS02 | 700 | 0.10 | 0.25 |
| 33 | NRS02 | 700 | 0.11 | 0.27 |
| 34 | NRS02 | 700 | 0.08 | 0.20 |
| 35 | NRS02 | 700 | 0.08 | 0.20 |
| 36 | NRS02 | 700 | 0.08 | 0.20 |
| 37 | MEHPPV | 900 | 0.08 | 0.20 |
| 38 | MEHPPV | 1200 | 0.06 | 0.15 |
| 39 | MEHPPV | 1600 | 0.04 | 0.10 |

*@ 0 V bias
**@500 nm, 0 V bias

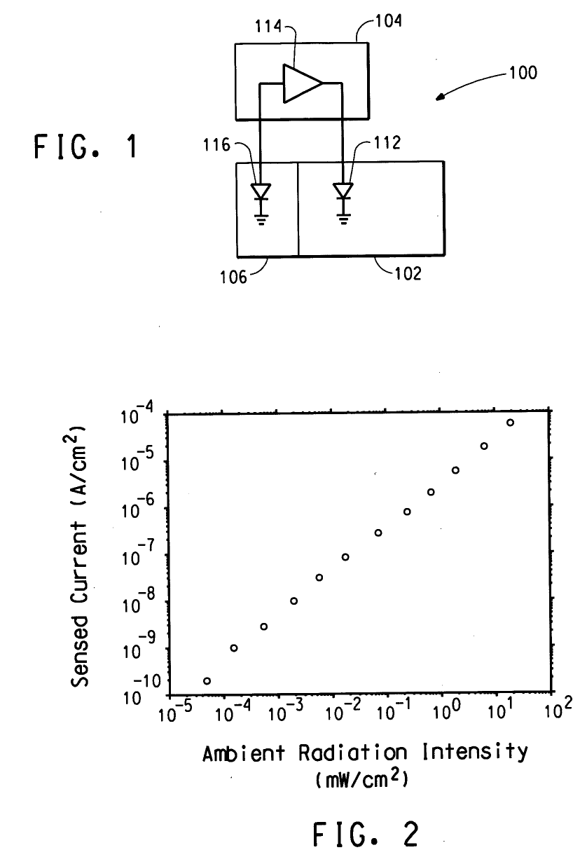

FIG. 2 includes a plot of ambient radiation intensity of the ambient radiation received by the radiation-sensing components 116 versus sensed current generated by the radiation-sensing components 116 in response to different ambient radiation intensities. In one embodiment, the ambient radiation is ambient light, which in one embodiment, reflects the level of lighting in a room.

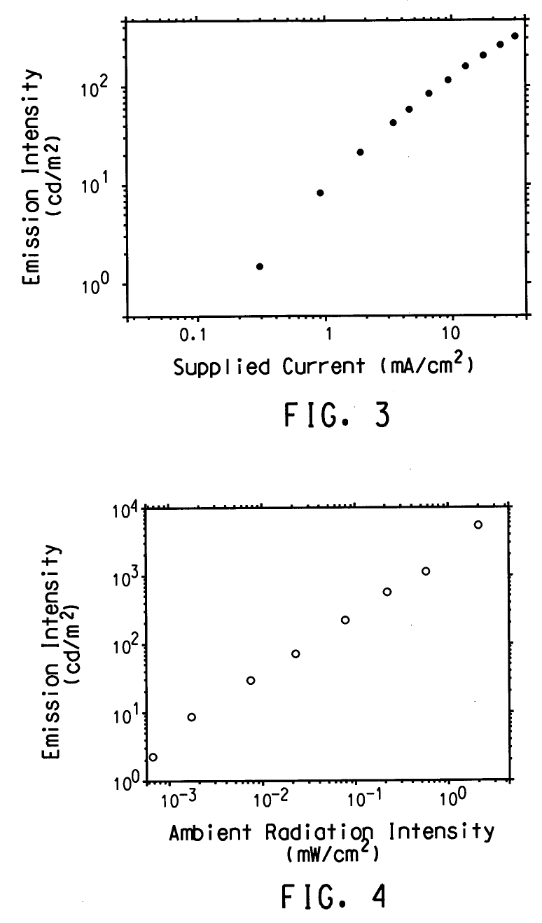

FIG. 3 includes a plot of current supplied to the radiation-emitting components 112 versus the emission intensity of radiation from the radiation-emitting components 112. In an embodiment where the display portion 102 includes more than one type of radiation-emitting components 112 (e.g., red, green, and blue light-emitting components), each type of radiation-emitting component may have the same or different relationships between supplied current and emission intensity.

FIG. 4 includes a plot of ambient radiation intensity versus emission intensity that can be derived from the data used to generate FIGS. 2 and 3. The log-log plot shows a linear relationship between the two.

The control portion 104 generates a control signal to control the emission intensity of radiation emitted from display portion 102 in response to the signals from the sensing portion 106. A current amplifier 114 is coupled to the radiation-emitting and radiation-sensing components 112 and 116. The current amplifier 114 is a bipolar transistor, a Darlington transistor, one or more other conventional electronic components or circuits, or any combination thereof that can amplify current.

In one embodiment (not illustrated), the control portion 104 includes other electronic components (in addition to the current amplifier 114), logic (e.g., software, firmware, etc.), or a combination thereof. The control portion 104 controls the supplied current to the radiation-emitting components 112 based at least in part on the sensed current from the radiation-sensing components 116. In another embodiment, the control portion 104 receives data signals (not illustrated) corresponding to the information that is to be displayed and determines how much the supplied current to the radiation-emitting components 112 is to be amplified based at least in part on the data signals and the sensed current from radiation-sensing components 116.

In one embodiment, the supplied current has a linear relationship to the sensed current, and the supplied current and sensed current have linear relationships to the emitted radiation intensity and the sensed radiation intensity, respectively. Based on the data used to generate FIGS. 2 and 3, the gain for the current amplifier 114 can be determined. Referring to FIGS. 2 and 3, the gain for the current amplifier is approximately 1×10⁴ in one embodiment. In an alternative embodiment, any one or more of the relationships described in the prior sentence is non-linear instead of linear.

In one embodiment, the control portion 104 controls the supplied current in a positive relation to the sensed current, such that the electronic components 112 emit a higher intensity of radiation when the ambient radiation is at a higher intensity. In another embodiment, the control system 104 controls the supplied current in a negative relation to the sensed current. In a further embodiment, the control portion 104 provides a minimum supplied current, a maximum supplied current, or both to the radiation-emitting electronic components 112. For example, referring to FIGS. 2 and 3, when the sensed current is at or below 1×10⁻⁹ A/cm² (ambient radiation intensity at 2×10⁻⁴ mW/cm²), the supplied current will be 0.3 mA/cm² (emission intensity at approximately 20 cd/m²). Similarly, when the sensed current is at or above 5×10⁻⁶ A/cm² (ambient radiation intensity at 20 mW/cm²), the supplied current will be 12 mA/cm² (emission intensity at approximately 150 cd/m²).

After reading this specification, skilled artisans will be able to implement hardware, software, or any combination thereof to allow the control of radiation-emitting electronic components 112 in a manner that meets their needs or desires.

The actual locations of the display portion 102, sensing portion 106, and control portion 104 with respect to an electronic device may vary. In one embodiment, the display portion 102, sensing portion 106, and control portion 104 are located within a single electronic device (e.g., electronic device 100). In one embodiment, the radiation-sensing components 116 may be arranged as a sensing matrix. For simplicity, only one radiation-sensing component 116 is illustrated in FIG. 1. In another embodiment, the sensing portion 106 may be disposed in an area underneath the display portion 102 within the electronic device 100. In one embodiment, the sensing portion 106 is on a different substrate and attached to the edge of the display portion 102.

In another embodiment (not illustrated), the sensing portion 106 is separate from the electronic device 100 that contains the display portion 102 and the control portion 104. In such an embodiment, a separate electronic device that contains the sensing portion 106 can be connected to the electronic device 100 via one or more wires, one or more cables, or any combination thereof.

In an alternative embodiment, the radiation-emitting and radiation-sensing components 112 and 116 are integrated into the same matrix. In such an embodiment, the display and sensing portions 102 and 106 are the same portion. In one specific embodiment, a pixel may contain three radiation-emitting components 112 (red, green, and blue) and one radiation-sensing component 116. In another specific embodiment (not illustrated), a pixel may contain three radiation-emitting components (red, green, and blue) and three radiation-sensing components (red, green, and blue). U.S. patent application Ser. Nos. 11/005,065, entitled Electronic Device and Method of Using the Same by Wang et al. filed Dec. 6, 2004 (Attorney Docket No. UC0431) and 10/646,306 entitled Organic Electronic Device Having Improved Homogeneity by Stevenson et al. filed Aug. 22, 2003 describe many different potential arrangements of radiation-sensing components 116 and their relationships to the display portion 102.

3. Electronic Device Including a Control Circuit

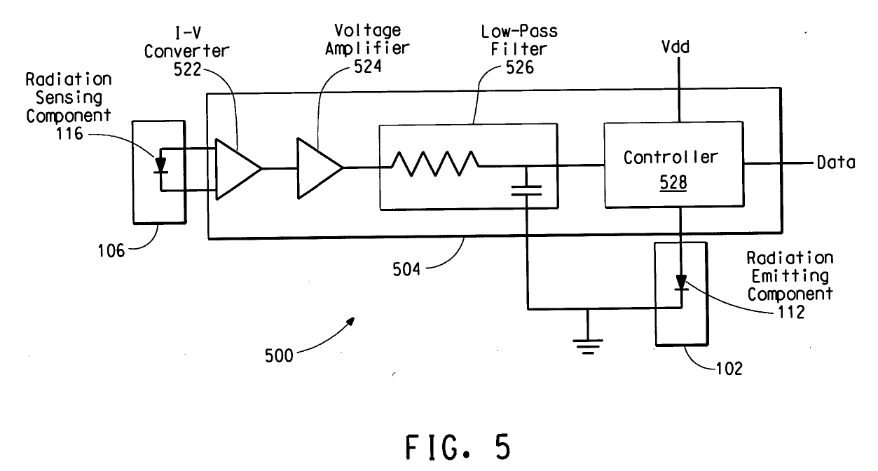

FIG. 5 includes a block diagram illustrating an electronic device 500 in accordance with another embodiment. The electronic device includes the display portion 102, the sensing portion 106, and a control portion 504. The display and sensing portions 102 and 106 can include any one or combination of embodiments previously described with respect to the electronic device 100. The control portion 504 is an alternative to the control portion 104 in the electronic device 100 of FIG. 1.

The control portion 504 comprises a current to voltage (“I-V”) converter 522, a voltage amplifier 524, a low-pass filter 526, and a controller 528. Each of the I-V converter, voltage amplifier 524, low-pass filter 526, and controller 528 is conventional. Ambient radiation is sensed by the sensing portion 106, which produces an output signal in the form of a current, in response to the ambient radiation. In one embodiment, the I-V converter 522 receives a signal from the sensing portion 106 (e.g., one or more electronic components 116) as a current and converts the current to a voltage. In one embodiment, the output signal from the I-V converter 522 (e.g., a voltage) is derived from the input signal to the I-V converter 522 (e.g., an output current from one or more of the radiation-sensing components 116). The voltage amplifier 524 amplifies the voltage from I-V converter 522 to produce an amplified voltage as an output. The output signal from the voltage amplifier 524 (e.g., an amplified voltage) is derived from the input signal to the voltage amplifier (e.g., the voltage from the I-V converter 522). The level of amplification of the voltage amplifier 524 may depend on the current produced by the sensing portion 106 and the characteristics of the controller 528. After reading this specification, skilled artisans will be able to determine the level of amplification that meets their needs or desires.

The low-pass filter 526 can be used so that the display portion 102 does not respond to undesired changes that are relatively fast in ambient radiation conditions. Examples can include a flickering fluorescent light, quickly turning on and off (or vice versa) a light, lightening, other similar relatively quick transient event, or any combination thereof. In one embodiment, the low-pass filer 526 is not designed to respond to changes that are less than 0.1 seconds, in another embodiment, changes less than 1 second, and in still another embodiment changes less than 11 seconds. In one embodiment, the low-pass filter 526 includes a resistive electronic component and a capacitive electronic component. The resistive electronic component has a terminal connected to an input terminal of the low-pass filter 526 and another terminal connected to an output terminal of the low-pass filter 526. The capacitive electronic component has an electrode connected to the output terminal of the low-pass filter and another electrode connected to a substantially constant voltage supply line. In one embodiment, the substantially constant voltage supply line is a Vₛₛ line or a V_{dd} line. In another embodiment, a different voltage, such as (Vₛₛ+V_{dd})/2, can be used.

In still further embodiments, the low-pass filter 526 can have different structures while still operating in a substantially similar manner. For example, the low-pass filter 526 can be used to determine an averaged value of signal received by the low-pass filter 526. The averaged value can be an average, median, geometric mean, or the like. The output signal from the low-pass filter 526 can be the averaged value. One or more conventional circuits can be designed to achieve averaged value. By using an averaged value, relatively fast changes in the ambient radiation conditions will have a relatively small overall impact. The output signal from the low-pass filter 526 is derived from its input signal.

In one embodiment, the controller 528 receives the output signal from the low-pass filter 526 and data from a controller or other part of the electronic device 500. A V_{dd} line is connected to the controller 528. Although not illustrated, the V_{dd} line, one or more other power supply lines, or any combination thereof may be connected to other parts of the electronic device 500, such as the I-V converter 522, voltage amplifier 524, etc.

The data received by the controller 528 reflects information that is to be displayed by the display portion 102. The output signal from the low-pass filter is used to adjust the intensity of the display without any significant change to the information presented to a user of the electronic device 500. In response to the signal from the low-pass filter 526, the controller 528 generates an output signal to the display portion 102 that is proportional to the ambient radiation conditions. The output signal from the controller 528 determines the emission intensity of radiation-emitting components 112 within the display portion 102. The output signal from the controller 528 can be a voltage or a current. In a specific embodiment, the output signal is a voltage that is directly or indirectly supplied to a control terminal (e.g., a gate electrode) of a driving transistor (not illustrated). The voltage at the control terminal can at least in part determine or otherwise affect the saturation current of the driving transistor. Such current from the driving transistor can be supplied to its corresponding radiation-emitting component 112.

The current voltage response of the current voltage converter 522 may be adjusted to depend on the type of display used. In one embodiment, more intense ambient radiation conditions (e.g., outdoors or in a brightly light room) will cause the display portion 102 to emit radiation at a higher relative intensity. In another embodiment, less intense ambient radiation conditions (e.g., no light or in a dimly light room) will cause the display portion 102 to emit radiation at a lower relative intensity.

In one embodiment, a YCrCb signal may have its Y component (luminance) adjusted (increased or decreased) before converting to a RGB (red-green-blue) components. Alternatively, RGB components can be individually adjusted, rather than the Y component, if the data is a YCrCb signal.

The ambient radiation conditions as sensed by the sensing portion 106 can change. For example, the user may take the electronic device 500 from a relatively bright location to a relatively dim location. After the electronic device 500 has been at the new location for some time (e.g., at least 1 second, at least 10 seconds, at least a minute, etc.), the signal from the sensing portion 106 changes, which in response causes the emission intensity from the display portion 102 to change via the control portion 504. Therefore, automatic intensity control occurs without manual control or other user interfacing.

Many different embodiments are possible for the control portion 504. A few are described herein to illustrate, but not limit, the invention. In one embodiment, the I-V converter 522, voltage amplifier 524, low-pass filter 526, or any combination thereof can be removed. For example, if the controller 528 receives a current as a signal, the I-V converter 522 and voltage amplifier 524 are not needed. A current amplifier (not illustrated) may or may not be substituted for the I-V converter 522 and voltage amplifier 524. In another embodiment, if transient response is not a concern, the low-pass filter 526 may or may not be needed. In still another embodiment, a voltage inverter (not illustrated) may be coupled between the voltage amplifier 524 and the low-pass filter 526. In a further embodiment, the voltage amplifier 524 may be configured to provide negative voltage amplification to provide an inverse relationship between the sensed ambient radiation conditions and the emission intensity from the radiation-emitting components 112. Such an embodiment may be useful in a backlight for non-emissive displays.

In an alternate embodiment, a current integrator (not illustrated) can be used in place of the I-V converter 522. The current integrator would convert the current from the radiation-sensing components 116 to a charge. In another embodiment, a modulation circuit can be substituted for the controller 528. The modulation circuit modulates the amplitude, frequency or pulse width of the signal sent to the display portion 102 to control the intensity of radiation emitted from the radiation-emitting components 112.

The control portion 504 may lie within an array, outside an array, or a combination thereof. For example, in an active matrix (“AM”) display, each radiation-emitting component 112 may have its own corresponding pixel driving circuit, which may be considered part of the controller 528. In one embodiment, all of the controller 528 and control portion 504 lie outside of the array except for the pixel driving circuits. Therefore, part of the control portion 504 and the display portion 102 would reside in the same array.

The electronic device 500 may contain nearly any number of control portions 504. The electronic device 500 may have as little as one control circuit. In another embodiment, the number of control portions 504 corresponds to the number of types of radiation-emitting electronic components 112. For example, a full-color display includes red-light emitting components, green-light emitting components, and blue-light emitting components. In one embodiment, three control portions 504 may be used: one for red, one for green, and one for blue. In another embodiment, more control portions 504 are used. In still another embodiment, the number of control portions 504 may be determined by the configuration of the display portion 102. For example, each control portion 504 may be used for a row or column of radiation-emitting components 112. After reading this specification, skilled artisans will be able to determine the number and configuration of control circuit(s) 504 for their specific needs or desires.

4. Electronic Device Including a Dual-Function Electronic Component

FIG. 6 includes a block diagram illustrating an electronic device 600 in accordance with another embodiment. The electronic device 600 includes a dual-function electronic component 612. The dual-function electronic component 612 is capable of being placed into one or two states, depending on the voltage across the dual-function electronic component 612. The dual-function electronic component 612 can emit radiation when the dual-function electronic component 612 is sufficiently forward biased (anode at a higher voltage compared to the cathode). The dual-function electronic component 612 can sense radiation when the dual-function electronic component 612 is sufficiently reverse biased (anode at a lower voltage compared to the cathode). In one embodiment, the dual-function electronic component 612 is a conventional OLED, such as any one of those as described in more detail in U.S. Pat. No. 5,504,323.

The electronic device 600 includes switches 622, 624, and 626. Switch 622 has a first terminal coupled to the first terminal of the dual-function electronic component 612 and a second terminal coupled to the controller 528. Switch 624 has a first terminal connected to the first terminal of the dual-function electronic component 612 and a second terminal connected to the second terminal of the dual-function electronic component 612. In other words, the switch 624 is connected in parallel with the dual-function electronic component 612. In one embodiment, the second terminals of the switch 624 and the dual-function electronic component 612 are connected to a power supply line, such as a Vₛₛ line. Switch 626 has a first terminal coupled to the first terminal of the dual-function electronic component 612 and a second terminal coupled to the controller 528.

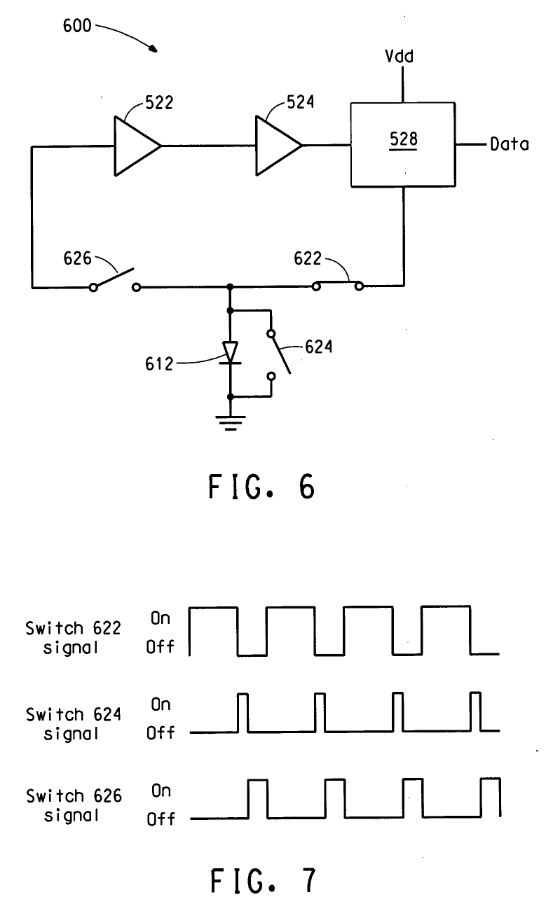

As illustrated in FIG. 6, switch 622 is closed and switches 624 and 626 are open. The timing for opening and closing the switches will be described in more detail with respect to FIG. 7. Examples of switches include diode and transistor structures, mechanical (e.g., manual) switches, electro-mechanical switches (e.g., relays), etc. The switches 622, 624, 626, or any combination thereof can be controlled by a switch controller (not illustrated). In one embodiment, a switch controller includes one or more electronic components, one or more circuits, one or more software components (e.g., a software agent), or any combination thereof having an output or produces a signal that controls a switch. A D flip-flop circuit, when properly configured, is an example of a switch controller. The switch controllers and the signals, logic, or combination thereof used to control the switch controllers may be incorporated into the controller 528 or may be located in other part(s) of the electronic device 600.

The electronic device 600 further includes the I-V converter 522, voltage amplifier 524, and controller 528. The options available to the control portion 504 are also available to the electronic device 600. For example, the electronic device 600 may include the low-pass filter 526 as previously described. In one embodiment, a current amplifier may be substituted for the I-V converter 522 and the voltage amplifier 524. Similar to the electronic device 500, many other embodiments are possible for electronic device 600.

FIG. 7 includes a graph illustrating the timing of signals for controlling the switches 622, 624, and 626. In an emitting mode, the switch 622 is closed, and the switches 624 and 626 are open. In this mode, data is received by the controller 528 and provides a signal, such as current, to the dual-function electronic component 612. The dual-function electronic component 612 retains some charge after the emitting mode ends (i.e., after switch 622 is opened).

During the emitting mode, some charge may accumulate within the dual-function electronic component 612. The amount of charge retained by the dual-function electronic component 612 may be related to the signal strength (e.g., amount of current) provided to the dual-function electronic component 612. Accumulated charge, if not dissipated, may affect the signal produced by the dual-function electronic component 612 when in a sensing state. Such effects from accumulated charge are undesired because, during sensing, the signal produced by the dual-function electronic component 612 may not accurately reflect the ambient radiation conditions. Therefore, in one embodiment, the accumulated charge is dissipated before sensing ambient radiation conditions. In a discharge mode, the switch 624 is closed, and the switches 622 and 626 are open. In this mode, any charge that may have accumulated within the dual-function electronic component 612 is dissipated. In this manner, readings during a sensing mode are not contaminated by residual charge and more accurately reflect ambient radiation conditions.

In one embodiment, the electronic device 600 is then placed into a sensing mode. In the sensing mode, the switch 626 is closed and the switches 622 and 624 are open. The dual-function electronic component 612 generates a signal (e.g., current) that corresponds to the ambient radiation conditions. In one embodiment, the dual-function electronic component 612 generates a greater amount of current as the intensity of ambient radiation (e.g., light intensity) increases. The controller 528 receives that signal or a derivation of that signal.

At the end of the sensing mode, the electronic device 600 returns to a emitting mode. The switch 626 is opened, and the switch 622 is closed. Additional data is provided to the controller 528. The controller 528 uses signals from one or more prior sensing modes to adjust the intensity when displaying to the user information corresponding to the data received. The process can continue for any number of further iterations.

The actual time that switch 622, 624, 626, or any combination thereof is opened or closed is highly variable and can be determined by the designer of the electronic device 600, the user of the electronic device 600, or a combination thereof. In one embodiment, the emitting mode is significantly longer than the times of the discharge and sensing modes. In the same embodiment, the discharge mode is kept as short as possible; just long enough to substantially discharge the dual-function electronic component 612. The sensing is long enough to get accurate readings for the ambient radiation conditions. Each of the emitting, discharge, and sensing modes are used during a single frame time (e.g., 16.7 ms). In another embodiment, the discharge and sensing modes are used once per a predetermined number of frame times. In still another embodiment, the discharge and sensing modes are used on a time basis, such as one discharge and sensing mode per second, 10 seconds, minute, etc. After reading this specification, skilled artisans will be able to determine the actual time periods and frequencies used for the emitting, discharging, and sensing modes that meets their needs or desires.

The electronic device 600 may have as little as one control circuit. In another embodiment, the number of control portions corresponds to the number of types of radiation-emitting electronic components 112. For example, a full-color display includes one type of dual-function electronic components that emit red light, another type of dual-function electronic components that emit green light, and still another type of dual-function electronic components that emit blue light. In one embodiment, three control portions may be used: one for red, one for green, and one for blue. In another embodiment, more control portions are used. In still another embodiment, the number of control portions may be determined by the configuration of a display. For example, each control portion may be used for a row or column of dual-function electronic components 612. After reading this specification, skilled artisans will be able to determine the number and configuration of control portion(s) for their specific needs or desires.

5. Alternative Embodiments

The concepts described herein can be used for many different types of electronic devices that include radiation-emitting components. The electronic devices can include active or passive matrix OLED displays. The electronic device can include a LCD, where the emission intensity for a backlight used with the LCD is automatically adjusted to ambient radiation conditions.

The concepts can also be applied to an electronic device that includes a sensor array. A switch similar to switch 624 can be configured to dissipate charge across radiation-sensing components. After a discharge mode, the sensor array can measure ambient radiation conditions before an external radiation source is turned on or otherwise activated. After a second, optional discharge mode, the sensor array can measure radiation intensity from the external radiation source. The measurements can be compared to determine more accurately the radiation intensity due to the external radiation source.

In still another embodiment, the position of the radiation-emitting or dual-function electronic component as illustrated in FIG. 5 or 6 may be reversed with respect to the controller 528. More specifically, the anode of the radiation emitting or dual-function electronic component can be connected to the V_{dd} line, and the controller 528 may lie between the cathode of the radiation emitting or dual-function electronic component and the Vₛₛ line.

6. Advantages

Embodiments described herein can be used to allow for automatic control of display brightness in an electronic device. Such control allows for hands-free operation of a display. In addition, an electronic device having a display can react to ambient radiation conditions and allow the display to potentially operate over a wider range of conditions. Users will appreciate that they will not have to strain their eyes because the display is too dim in a bright room or too intense in a dim room. The electronic devices may also have better power conservation characteristics. When the electronic device is taken from a bright room to a dimly lit room, the emission intensity of a display will automatically be reduced and result in less power consumption. Human intervention is not required. Therefore, an electronic device that incorporates the automatic intensity control may have longer battery life compared to a conventional electronic device.

The concepts described herein can be used for a wide variety of electronic devices including active or passive matrix displays or non-emissive matrices, such as sensor arrays. A wide variety of radiation-emitting, radiation-sensing, and dual-function electronic components can be used with the electronic device. The integration of the electronics within existing devices is relatively straightforward.

### EXAMPLES

The invention will be further described in the following examples, which do not limit the scope of the invention described in the claims.

### Example 1

Example 1 demonstrates that a dual-function backlight display can be made that includes the arrangement as illustrated in FIG. 5.

The dual-function backlight display uses two polymer electronic components: one to sense and one to emit light. One area of the display controls the brightness of the entire display. In one specific embodiment, one of the sidebar icons in a cell phone functions as a radiation-sensing component that, at least in part, is used to determine how hard to drive a backlight panel (e.g., a mini-lamp, a set of inorganic LEDs, or a flat-panel backlight that includes one or more OLEDs) for passive displays (such as LCD). The display can also be an emissive display of which the magnitude of the signal (e.g., current) is controlled by the output signal of the control portion 504.

### Example 2

Example 2 demonstrates that automatic intensity control can be used with an electronic device.

Example 2 is similar to Example 1 in that a radiation-sensing component is used with an LED or a minilamp. In one embodiment, a variety of photosensing components can be used for the radiation-sensing component. An example includes an inorganic photodiode, a-Si photovoltaic cell, a CdS photoconductive cell, a small molecule photovoltaic cell, a polymer photovoltaic cell, or the like. An inorganic LED, a small-molecule organic LED, a polymer LED, a commercial minilamp, or any combination thereof can be used as the radiation-emitting component. Automatic intensity control can be achieved with a substantially constant contrast ratio (ambient radiation intensity varying from dark to larger than 200 μW/cm²).

### Example 3

Example 3 demonstrates that automatic intensity control can be used with an inverse relationship between ambient radiation conditions and emission intensity.

Example 3 is similar to Example 2 except that a voltage inverter in inserted into the control portion 504 in FIG. 5. As the ambient radiation intensity decreases, the emission intensity from a backlighting system increases. Such an application can be useful for an LCD or electrochromic display.

### Example 4

Example 4 demonstrates that an electronic component can perform as a dual-function electronic component.

Example 4 uses an LED as both a radiation-sensing component and a radiation-emitting component, similar to dual-function electronic component 612. The LED can be an inorganic LED, small-molecule OLED, or a polymer OLED. The circuit design similar to that illustrated in FIG. 6 can be used. Automatic intensity control is achieved with a controlled contrast ratio within the test range (ambient radiation intensity varying from dark to 200 μW/cm²).

### Example 5

Example 5 demonstrates that a current integrator can be used in signal processing.

In Example 5, a current integrator (i.e., a current to charge converter) is used as the first stage signal processor instead of the I-V converter and voltage amplifier in Examples 1 and 2. Radiation-sensing and radiation-emitting components as previously described can be used in the electronic device. The current integrator allows the use of very small signals from the radiation-sensing component to, at least in part, control the strength of the signals provided by a controller to the radiation-emitting component. Therefore, the radiation-sensing component can have a small size, for example a pixel area of a display, for the intensity control.

### Example 6

Example 6 demonstrates that a dual-function electronic component can be used with a current integrator for signal processing.

A dual-function electronic component is substituted for the separate radiation-sensing and radiation-emitting components in Example 5. The dual-function electronic components can be used to form a passive matrix OLED display with 96 columns and 64 rows.

### Example 7

Example 7 demonstrates that automatic intensity/contrast control can be used with a passive matrix OLED display.

In Example 7, a radiation-sensing OLED is used to sense ambient radiation, and a control circuit, such as the one with respect to FIG. 5 is used to provide an appropriate drive signal (e.g., voltage) to a matrix of polymer OLEDs. In the passive matrix polymer OLED display, there are two control voltages involved. One is used to activate a row, while the other provides a drive voltage to the polymer OLED in the row. The drive voltage is, at least in part, controlled by the sense signal provided by a radiation-sensing component, allowing the display to adjust its brightness based on the intensity of ambient radiation.

### Example 8

Example 8 demonstrates that an active matrix polymer OLED display can use separate radiation-sensing and radiation-emitting components.

A polymer OLED is used as the radiation-sensing component and two field-effect transistors and another polymer OLED pixels are used to construct a model pixel of active matrix polymer OLED display. A controller similar to that described with respect to FIG. 5 is used to process the sensing signal and to modulate a pulse-width of a voltage to an electrode of the radiation-emitting component.

### Example 9

Example 9 demonstrates that brightness for a passive matrix display can be controlled by pulse-width modulation.

Example 9 is similar to Example 7; however, instead of using the sensing signal from the radiation-sensing OLED to control a drive signal (e.g., voltage or current) to the radiation-emitting OLED, the sensing signal is used to control the drive pulse-width by using a current-to-pulse width converter.

### Example 10

Example 10 demonstrates that brightness for an active matrix display can be controlled by pulse-width modulation.

Example 10 is similar to that shown in Example 7; however, instead of using the sensing signal from the radiation-sensing OLED to control a drive signal (e.g., voltage or current) to the radiation-emitting OLED), the sensing signal is used to control the drive pulse width by using a current-to-pulse width converter.

### Example 11

Example 11 demonstrates that the concepts described herein can be extended to an electronic device having a display portion that exhibits non-linear intensity control.

Instead of providing constant contrast over broad ambient radiation conditions, in certain applications, it is desirable to have a contrast control in a certain range of intensity from ambient radiation (L1, L2). The display provides a constant level of high brightness above L2 and a constant level of low brightness below L1. Such function can be achieved by modifying circuits in FIGS. 5 and 6. The constant level of low brightness can be achieved by adding a constant minimum drive signal (e.g., voltage) equivalent to that brightness to the controller. The constant level of high brightness can be achieved by setting up a signal (e.g., current) limiter for the signal supplied to the controller 528.

In another embodiment, another type of circuit can be used within the controller (such as a logarithmic converter). The output signal from the controller can be varied in any desired relation with the intensity of the ambient radiation.

Note that not all of the activities described above in the general description or the examples are required, that a portion of a specific activity may not be required, and that further activities may be performed in addition to those described. Still further, the order in which each of the activities are listed are not necessarily the order in which they are performed. After reading this specification, skilled artisans will be capable of determining what activities can be used for their specific needs or desires.

In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense and all such modifications are intended to be included within the scope of invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims.

It is to be appreciated that certain features of the invention which are, for clarity, described above and below in the context of separate embodiments, may also be provided in combination in a single embodiment. Conversely, various features of the invention that are, for brevity, described in the context of a single embodiment, may also be provided separately or in any subcombination. Further, reference to values stated in ranges includes each and every value within that range.

What is claimed is:

1. An electronic device comprising:
a low-pass filter configured to receive an output signal from a radiation-sensing component or a first derived signal derived from the output signal to produce a filtered signal, wherein the output signal corresponds to an intensity of ambient radiation sensed by the radiation-sensing component; and
a first radiation-emitting component designed to emit a first radiation based at least in part on the filtered signal or a second derived signal derived from the filtered signal.

2. The electronic device of claim 1, further comprising a first controller, wherein:
the electronic device is configured such that the output signal from the radiation-sensing component or the first derived signal passes through the low-pass filter before reaching the first controller; and
the first controller is configured to control an intensity of the first radiation emitted from the first radiation-emitting component at least partially in response to the filtered signal or the second derived signal.

3. The electronic device of claim 2, further comprising an amplifier configured to amplify the output signal from the radiation-sensing component or a third derived signal derived from the output signal to produce the first derived signal.

4. The electronic device of claim 3, further comprising an I-V converter configured to convert the output signal, which is a current, to the third derived signal, which is a voltage, wherein the amplifier is configured to receive the third derived signal.

5. The electronic device of claim 2, wherein the first radiation-emitting component comprises a first organic active layer.

6. The electronic device of claim 5, further comprising other radiation-emitting components substantially identical to the first radiation-emitting component, wherein the first controller is configured to control intensities of the first radiation emitted from the other radiation-emitting components at least partially in response to the filtered signal.

7. The electronic device of claim 5, further comprising a second radiation-emitting component and a third radiation-emitting component, wherein:
the first radiation has a first emission maximum at a first wavelength;
the second radiation-emitting component is designed to emit a second radiation having a second emission maximum at a second wavelength;
the third radiation-emitting component is designed to emit a third radiation having a third emission maximum at a third wavelength; and
the first, second, and third wavelengths are different compared to one another.

8. The electronic device of claim 7, further comprising a second controller and a third controller, wherein:
the second controller is configured to control an intensity of the second radiation emitted from the second radiation-emitting component at least partially in response to the filtered signal; and
the third controller is configured to control an intensity of the third radiation emitted from the third radiation-emitting component at least partially in response to the filtered signal.

9. The electronic device of claim 7, wherein:
the second radiation-emitting component comprises a second organic active layer;
the third radiation-emitting component comprises a third organic active layer; and
the first, second, and third organic active layers are different compared to one another.

10. The electronic device of claim 5, wherein the radiation-sensing component comprises a second organic active layer.

11. The electronic device of claim 1, wherein the low-pass filter has an input terminal and an output terminal, wherein the low-pass filter comprises:
a resistive electronic component having a first terminal and a second terminal, wherein the first terminal is connected to the input terminal, and the second terminal is connected to the output terminal; and
a capacitive electronic component having a first electrode and a second electrode, wherein the first electrode is connected to the input terminal, and the second electrode is designed to be at a substantially constant voltage during at least a portion of time when the electronic device operates.

12. An electronic device comprising:
a first dual-function electronic component having a first terminal and a second terminal, wherein the first dual-function electronic component is designed to emit a first radiation while in a first mode and to sense ambient radiation while in a second mode; and
a first switch having a first terminal and a second terminal, wherein:
the first terminal of the first switch is connected to the first terminal of the first dual-function electronic component;
the second terminal of the first switch is connected to the second terminal of the first dual-function electronic component; and
the first switch is configured to be:
closed at least during a portion of time while the first dual-function electronic component is between the first and second modes;
open at least during a portion of time while the first dual-function electronic component is in the first mode; and
open at least during a portion of time while the first dual-function electronic component is in the second mode.

13. The electronic device of claim 12, further comprising a first controller and a second switch, wherein:
the second switch has a first terminal connected to the first terminal of the first dual-function electronic component and a second terminal connected to an output of the first controller; and
the first controller is configured, when the second switch is closed, to control an intensity of the first radiation emitted from the first dual-function component.

14. The electronic device of claim 13, further comprising an amplifier and a third switch, wherein:
the third switch has a first terminal connected to the first terminal of the first dual-function electronic component and a second terminal coupled to an input of the amplifier; and
the amplifier is configured, when the third switch is closed, to amplify an output signal from the dual-function electronic component or a first derived signal derived from the output signal to produce an amplified signal.

15. The electronic device of claim 14, further comprising an I-V converter configured to convert the output signal, which is a current, to the first derived signal, which is a voltage.

16. The electronic device of claim 15, wherein the first controller is configured to receive the amplified signal or a second derived signal from the amplified signal.

17. The electronic device of claim 16, further comprising other dual-function electronic components substantially identical to the first dual-function electronic component, wherein the first controller is configured to control intensities of the first radiation emitted from the other dual-function electronic components.

18. The electronic device of claim 12, wherein the first dual-function electronic component comprises a first organic active layer.

19. The electronic device of claim 18, further comprising a second dual-function electronic component and a third dual-function electronic component, wherein:
the first radiation has a first emission maximum at a first wavelength;
the second dual-function electronic component is designed to emit a second radiation having a second emission maximum at a second wavelength;
the third dual-function electronic component is designed to emit a third radiation having a third emission maximum at a third wavelength; and
the first, second, and third wavelengths are different compared to one another.

20. The electronic device of claim 19, wherein:
the second dual-function electronic component comprises a second organic active layer;
the third dual-function electronic component comprises a third organic active layer; and
the first, second, and third organic active layers are different compared to one another.

21. An electronic device comprising:
a current amplifier that is configured to amplify an output current from a radiation-sensing component to produce an amplified current, wherein the output current corresponds to an intensity of ambient radiation sensed by the radiation-sensing component; and
a first radiation-emitting component configured to emit a first radiation based at least in part on the amplified current.

22. The electronic device of claim 21, further comprising a controller that is configured to control an intensity of the first radiation emitted from the first radiation-emitting component.

23. The electronic device of claim 22, further comprising a low-pass filter configured to receive the amplified current to produce a filtered current to be received by the controller.

24. The electronic device of claim 22, wherein the first radiation-emitting component comprises a first organic active layer.

25. The electronic device of claim 24, further comprising other radiation-emitting components substantially identical to the first radiation-emitting component, wherein the controller is configured to control intensities of the first radiation emitted from the other radiation-emitting components.

26. The electronic device of claim 24, further comprising a second radiation-emitting component and a third radiation-emitting component, wherein:
the first radiation has a first emission maximum at a first wavelength;
the second radiation-emitting component is designed to emit a second radiation having a second emission maximum at a second wavelength;
the third radiation-emitting component is designed to emit a third radiation having a third emission maximum at a third wavelength; and
the first, second, and third wavelengths are different compared to one another.

27. The electronic device of claim 26, wherein:
the second radiation-emitting component comprises a second organic active layer;
the third radiation-emitting component comprises a third organic active layer; and
the first, second, and third organic active layers are different compared to one another.

28. An electronic device comprising:
an I-V converter configured to convert an output current from a radiation-sensing component to a converted voltage, wherein the output current corresponds to an intensity of ambient radiation sensed by the radiation-sensing component;
a voltage amplifier that is connected in series with the I-V converter, wherein the voltage amplifier is configured to amplify the converted voltage from the I-V converter to produce an amplified voltage; and
a first radiation-emitting component configured to emit a first radiation based at least in part on the amplified voltage or a first derived signal derived from the amplified voltage.

29. The electronic device of claim 28, further comprising a controller, wherein the controller is configured to control an intensity of the first radiation emitted from the first radiation-emitting component at least partially in response to the amplified voltage or the first derived signal.

30. The electronic device of claim 29, wherein the first radiation-emitting component comprises a first organic active layer.

31. The electronic device of claim 30, further comprising other radiation-emitting components substantially identical to the first radiation-emitting component, wherein the controller is configured to control intensities of the first radiation emitted from the other radiation-emitting components.

32. The electronic device of claim 30, further comprising a second radiation-emitting component and a third radiation-emitting component, wherein:
the first radiation has a first emission maximum at a first wavelength;
the second radiation-emitting component is designed to emit a second radiation having a second emission maximum at a second wavelength;
the third radiation-emitting component is designed to emit a third radiation having a third emission maximum at a third wavelength; and
the first, second, and third wavelengths are different compared to one another.

33. The electronic device of claim 32, wherein:
the second radiation-emitting component comprises a second organic active layer;
the third radiation-emitting component comprises a third organic active layer; and
the first, second, and third organic active layers are different compared to one another.

34. The electronic device of claim 30, wherein the radiation-sensing component comprises a second organic active layer.

35. The electronic device of claim 28, further comprising a low-pass filter configured to receive the amplified voltage to produce a filtered signal, wherein the filtered signal is the first derived signal.
